(19) United States
(12) Patent Application Publication
(10) Pub. No.: US 2008/0126250 A1
(43) Pub. Date: May 29, 2008

(54) Interactive television service supply system for providing online payment for interactive TV users by integrating bank payment scheme

(76) Inventor: Chien-Liang Chen, Taipei City (TW)

Correspondence Address: HARNESS, DICKEY & PIERCE, P.L.C., P.O. BOX 8910, RESTON, VA, 20195, US

(21) Appl. No.: 11/527,591

(22) Filed: Sep. 27, 2006

(51) Int. Cl. G06Q 20/00; G06Q 40/00

(52) U.S. Cl. 705/44; 705/39

(57) ABSTRACT

An interactive television service supply system for providing online payment for interactive TV users by integrating a bank payment scheme is provided. The system is connected with at least one set-top box to the finance system of a bank financial system via a network, for the users to perform payment operation. The device includes an interactive television control center for receiving a payment message sent by the set-top box, deliver the payment message to a payment scheme communication gate, then transmit it to a bank communication gate, and then transmit it to the bank financial system for performing a payment operation. Meanwhile, the system receives a response message sent by the bank financial system, and transmits it to the interactive television control center via the payment scheme communication gate, such that the interactive television control center provides a payment confirmation message to the set-top box.

### BACKGROUND OF THE INVENTION

1. Field of Invention

The present invention relates to interactive television service supply system, and more particularly, to an interactive television service supply system for providing online payment for interactive TV users by integrating a bank payment scheme.

2. Related Art

Currently, the scheme for providing real-time interactive online payment has not been provided in common interactive television services, for example, online shopping. Users need to confirm by telephone to tell their credit card number, or pay in other ways like funds transfer, remittance, etc. For users, it is very inconvenient and there are worries about privacy and security. For managers of interactive televisions, the monetary flow of trade cannot be simplified and performance of the interactive television online trade and real-time payment cannot be more effectively enhanced.

### SUMMARY OF THE INVENTION

In view of the above problem, a main object of the present invention is to provide an interactive television service supply system for providing online payment for interactive TV users by integrating a bank payment scheme, in order to solve the inconvenient problem caused by the traditional payment scheme for users.

In order to achieve the above object, the present invention provides an interactive television service supply system for providing online payment for interactive TV users by integrating a bank payment scheme, which is connected at least one set-top box to a bank finance system, for a user to perform payment operations at the bank finance system through the set-top box. Such an interactive television service supply system includes an interactive television control center, a payment scheme communication gate, and a bank communication gate.

The interactive television control center is connected with the set-top box via a network. When a user performs the online payment operation via an interactive television and its set-top box, the set-top box will send a payment message to the interactive television control center. At this time, the interactive television control center will deliver the payment message to the payment scheme communication gate, then the payment scheme communication gate transmits it to the bank communication gate, so as to be connected with the bank finance system for performing the payment operation. When the bank financial system completes the payment operation, it sends a response message, and transmits it to the interactive television control center via the payment scheme communication gate, so that the interactive television control center will provide a payment confirmation message to the set-top box.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow for illustration only, and which thus is not limitative of the present invention, and wherein:

FIG. 1 is a schematic view of an embodiment of the present invention; and

FIG. 2 is a schematic view of a part of the elements according to the embodiment of the present invention.

### DETAILED DESCRIPTION OF THE INVENTION

To facilitate further understanding of the objects, constructions, features, and functions of the present invention, a detailed illustration is made as follows in combination with embodiments.

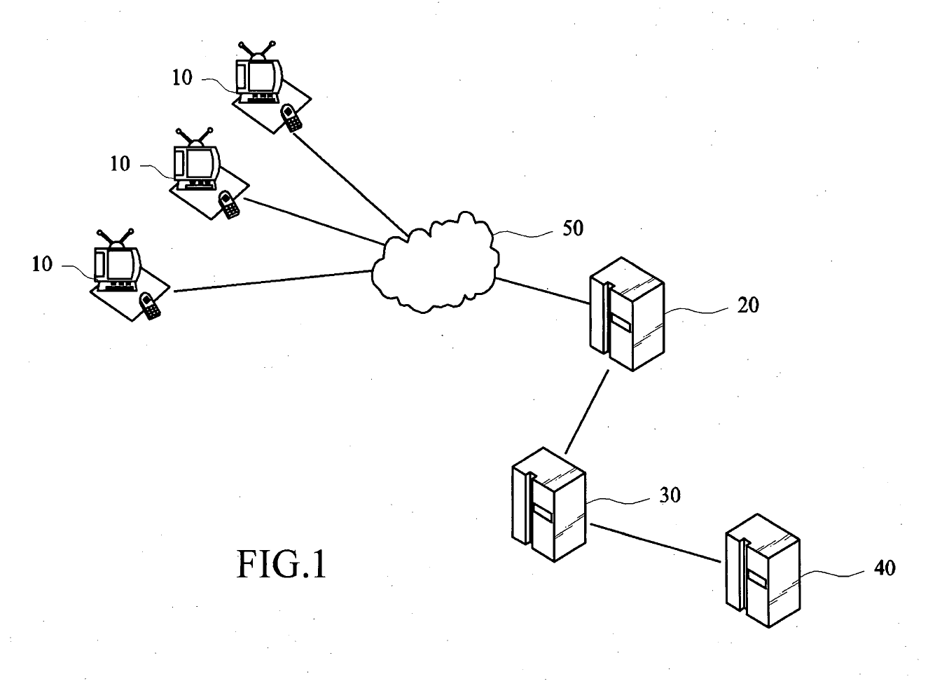

Referring to FIG. 1, it shows an interactive television service supply system for providing online payment for interactive TV users by integrating an interactive television and the bank payment scheme provided in an embodiment of the present invention, which is connected with a plurality of set-top box 10 to provide payment service. Meanwhile, a user may input financial information at the set-top box 10 via a inserting card reader device, a swiping card reader device, a sensitive reader device, etc. or in a manual way, so that the bank may directly deduct money for the payment operation. Such a system for providing online payment includes an interactive television control center 20, a payment scheme communication gate 30, and a bank communication gate 40.

The set-top boxes 10 are connected to the network 50, through which the set-top boxes 10 are connected with the interactive television control center 20. When a set-top box 10 sends a service request, the interactive television control center 20 will transmit service to the set-top box 10 via the network 50 according to the service request.

If the service request transmitted by a user via the set-top box 10 is the online payment, the user may input the financial certification and membership identification by a device such as a financial chip card, so that the set-top box 10 will send a payment message. When the interactive television control center 20 receives the payment message sent by the user from the set-top box 10, the interactive television control center 20 will transmit it to the payment scheme communication gate 30 according to the payment message with the membership identification. This payment message includes the required payment amount, the financial certification of the user, and the payment service request corresponding to the payment amount. Then, the payment scheme communication gate 30 is connected with the bank communication gate 40, and designates the bank communication gate 40 to be connected with the bank finance system according to the payment related message, in order to deduct appointed money from the specific account, and transfer it into the appointed account of the interactive television service supplier.

After the bank finance system completes deduction and transfer, it will transmit a response message to the payment scheme communication gate 30 via the bank communication gate 40, and then the payment scheme communication gate 30 transfers it to the interactive television control center 20. After the interactive television control center 20 receives the response message, it will transmit the payment confirmation message to the set-top box 10, so that the user receives the content related to the payment confirmation message via the set-top box 10.

Thus, the users need not prepay the payment service in advance or use telephone communication or other ways such as transfer and remittance for payment. As long as the payment service is required, the user may perform online payment directly with his/her own bank account through the interactive payment scheme of the set-top box 10 connected with the payment scheme communication gate 30 and the bank terminal communication gate 40, thus increasing the convenience of usage.

The way of payment may be that, after the interactive television control center 20 is connected with the bank communication gate 30, the user inputs his/her financial certification at the set-top box, for example, inputs the account number and the password corresponding to the account number, or the card number of a credit card and the password corresponding to the card number, or only needs to input related authentication password. Then, the interactive television control center 20 will transmit the user's membership identification in database together with the financial certification to the bank finance system, which will check whether the related information (for example, password verification) in the user's membership identification accords with the account and the owner of credit card. It is used as a recognition scheme in order to avoid the situation that the card number of credit card or the account number of user is stolen as payment. Certainly, the information may also be stored in advance in the set-top box or the database of interactive television control center 20. The user needs only log in with his/her membership at the set-top box 10 beforehand, and when payment is required, the interactive television control center 20 will automatically transmit the related information to the bank terminal after a payment message is sent.

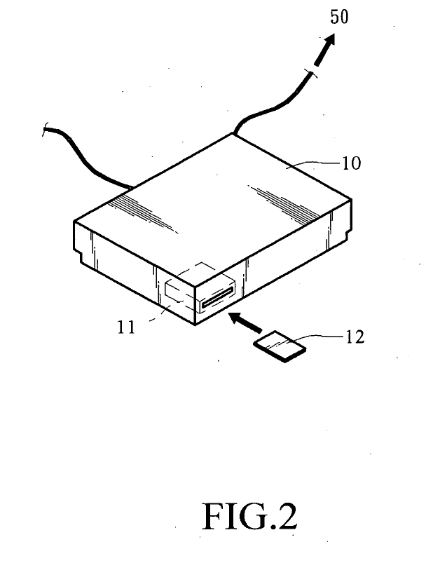

Referring to FIG. 2, a card reader device 11 disposed on the set-top box 10 may also be used to read a smartcard 12 (for example, a financial chip card), a credit card, etc. When a user needs to pay, it is only required to insert the smartcard 12 or the credit card and input the password, thus the financial certification is transmitted to the database of bank financial system for comparison and deduction. After the deduction is finished, the database of bank terminal may transmit a deduction complete message to the payment scheme communication gate 30 via the bank communication gate 40, then the payment scheme communication gate 30 transmits it to the interactive television control center 20 for validation, so as to provide the payment service confirmation message to the set-top box 10.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An interactive television service supply system for providing online payment for interactive TV users by integrating a bank payment scheme, connected with at least one set-top box to a bank finance system via a network, for a user to perform a payment operation at the bank finance system through the set-top box, comprising:
an interactive television control center connected with the set-top box via the network, for receiving a payment message sent by the set-top box;
a payment scheme communication gate, wherein the interactive television control center delivers the payment message to the payment scheme communication gate; and
a bank communication gate, connected with the payment scheme communication gate, for receiving the payment message and transmitting it to the bank finance system for the payment operation, and meanwhile, receiving a response message sent by the bank finance system, so as to be received by the payment scheme communication gate, and transmitting the response message to the interactive television control center, such that the interactive television control center provides a payment confirmation message to the set-top box terminal.

2. The interactive television service supply system for providing online payment for interactive TV users by integrating a bank payment scheme as claimed in claim 1, wherein the payment message comprises a payment amount, a financial certification of the user, and a payment service request corresponding to the payment amount.

3. The interactive television service supply system for providing online payment for interactive TV users by integrating a bank payment scheme as claimed in claim 2, wherein the financial certification is an account number and a password corresponding to the account number.

4. The interactive television service supply system for providing online payment for interactive TV users by integrating a bank payment scheme as claimed in claim 2, wherein the financial certification is a card number of a credit card and a password corresponding to the card number of the credit card.

5. The interactive television service supply system for providing online payment for interactive TV users by integrating a bank payment scheme as claimed in claim 2, wherein the financial certification is an authentication password.

6. The interactive television service supply system for providing online payment for interactive TV users by integrating a bank payment scheme as claimed in claim 2, wherein the set-top box has a card reader device for reading the financial certification.

7. The interactive television service supply system for providing online payment for interactive TV users by integrating a bank payment scheme as claimed in claim 6, wherein the financial authentication information is read from a credit card.

8. The interactive television service supply system for providing online payment for interactive TV users by integrating a bank payment scheme as claimed in claim 6, wherein the financial authentication information is read from a smartcard.

9. The interactive television service supply system for providing online payment for interactive TV users by integrating a bank payment scheme as claimed in claim 8, wherein the smartcard is a financial chip card.
